(19) United States
(12) Patent Application Publication
(10) Pub. No.: US 2026/0230491 A1
(43) Pub. Date: Aug. 6, 2026

(54) Automated Network Environment Compliance Control

(71) Applicant: Zscaler, Inc., San Jose, CA (US)

(72) Inventors: Roi Inbar, Tel-Aviv (IL); Shoham Danino, Tel-Aviv (IL)

(73) Assignee: Zscaler, Inc., San Jose, CA (US)

(21) Appl. No.: 19/043,682

(22) Filed: Feb. 3, 2025

(51) Int. Cl. H04L 9/40

(52) U.S. Cl. CPC H04L 63/1433

(57) ABSTRACT

Systems and methods for automated network environment compliance control include receiving one or more security findings associated with an organization's network environment; analyzing, by a Large Language Model (LLM) agent, the one or more security findings to identify compliance requirements across a plurality of compliance frameworks; determining one or more compliance controls based on the compliance requirements identified by the LLM agent; validating each of the one or more compliance controls; and generating a compliance report including one or more implementation strategies and risk analyses for each validated compliance control.

### FIELD OF THE DISCLOSURE

The present disclosure relates generally to networking and computing. More particularly, the present disclosure relates to systems and methods for automated network environment compliance control.

### BACKGROUND OF THE DISCLOSURE

Implementing compliance controls in a network environment requires aligning an organization's technical and operational measures with relevant legal and industry regulations. This alignment involves configuring network infrastructure, establishing access restrictions, monitoring system events, and maintaining documented policies that reflect both security best practices and specific compliance mandates. Given the dynamic nature of cyber threats and evolving regulatory requirements, organizations often face challenges in determining which controls to prioritize, ensuring those controls are correctly configured, and maintaining ongoing compliance through continuous monitoring and audits. Limited resources, differing interpretations of regulations, and the complexities of integrating disparate systems add further difficulty, leading to potential gaps in coverage or misapplication of controls if not carefully managed and validated.

### BRIEF SUMMARY OF THE DISCLOSURE

The present disclosure relates to systems and methods for automated network environment compliance control. The present disclosure includes methods having steps, processing devices configured to implement the steps, a cloud-based system configured to implement the steps, and as a non-transitory computer-readable medium storing instructions for programming one or more processors to execute the steps. The steps include receiving one or more security findings associated with an organization's network environment; analyzing, by a Large Language Model (LLM) agent, the one or more security findings to identify compliance requirements across a plurality of compliance frameworks; determining one or more compliance controls based on the compliance requirements identified by the LLM agent; validating each of the one or more compliance controls; and generating a compliance report including one or more implementation strategies and risk analyses for each validated compliance control.

The steps can further include performing a context-aware search of a knowledge base storing compliance controls to retrieve a set of potentially relevant compliance controls. The validating can include (i) verifying control identifiers against a knowledge base, (ii) performing content validation to confirm applicability of the one or more compliance controls to the security findings, and (iii) computing a relevance score for each validated compliance control. The steps can include refining at least one of the one or more compliance controls in response to a relevance score falling below a predetermined threshold. The compliance report can include the validated compliance controls, assigned relevance scores, and implementation guidance for each of the validated compliance controls. The determining one or more compliance controls can include performing framework-specific control searches that tailor retrieval based on an identified regulatory or industry standard. The determining one or more compliance controls can include identifying related controls that supplement or complement primary controls to provide a holistic compliance strategy. The validating can include cross-referencing identified compliance controls with official regulatory documentation to confirm alignment with latest compliance standards; and performing a gap analysis to highlight compliance deficiencies, thereby enabling proactive remediation strategies. Generating the compliance report can include (i) identifying control dependencies and relationships among validated compliance controls, (ii) documenting compensating controls for areas where primary controls alone are insufficient, and (iii) providing continuous monitoring requirements for ongoing compliance assurance. The steps can include identifying the one or more security findings via an automated cloud-based system, or receiving the one or more security findings from an administrator of the organization.

### BRIEF DESCRIPTION OF THE DRAWINGS

The present disclosure is detailed through various drawings, where like components or steps are indicated by identical reference numbers for clarity and consistency.

FIG. 1 is a diagram of a distributed cloud-based system.

FIG. 2 is a flow diagram of an automated compliance control mapping workflow.

FIG. 3 is a flowchart of a process for automated compliance control.

### DETAILED DESCRIPTION OF THE DISCLOSURE

The present invention provides an automated system that leverages a Large Language Model (LLM) agent with Retrieval-Augmented Generation (RAG) capabilities to map security findings to relevant compliance controls across multiple frameworks. By employing a dual-tool architecture, comprising a Control_Search tool for retrieving framework-specific controls and a Validate_Control tool for verifying their accuracy and applicability, the system significantly reduces manual effort and expertise requirements. Through iterative refinement, relevance scoring, and detailed implementation guidance, the invention delivers high-precision compliance control recommendations that help organizations address vulnerabilities and maintain strong, consistent compliance postures.

### Cloud-based System

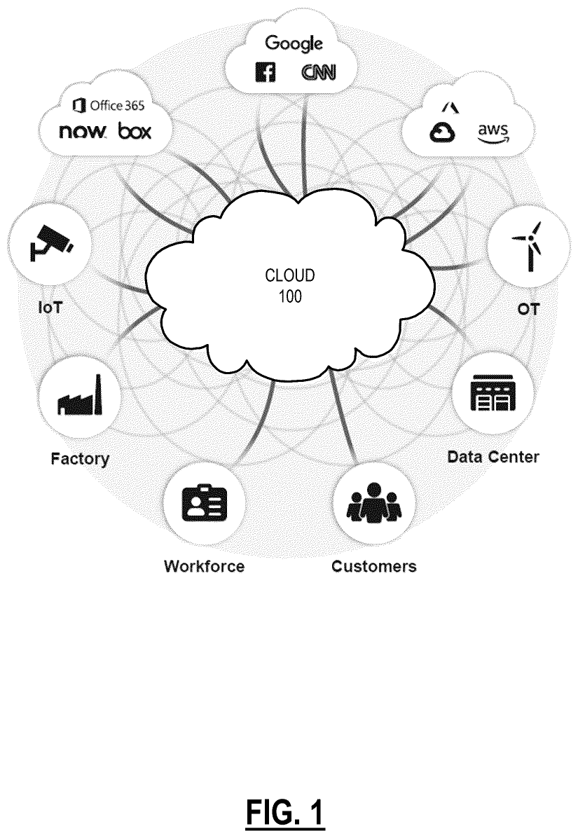

FIG. 1 is a diagram of a distributed cloud-based system. Zscaler, the assignee and applicant of the present invention, operates a globally distributed, cloud-native platform known as the Zero Trust Exchange (ZTE), i.e., the cloud 100, which serves as a secure access and inspection point for traffic between users, devices, and applications across the internet, Software-as-a-Service (SaaS) environments, and private data centers. Its multi-tenant architecture routes user traffic to the nearest data center, where security enforcement nodes inspect and enforce policies. This design not only reduces latency by leveraging geographic proximity but also centralizes policy management. Each tenant's policies, logs, and configurations remain securely segregated within this shared cloud environment, allowing the cloud 100 to streamline updates and patches while preserving data isolation.

A significant strength of the cloud 100 is its ability to manage tenant asset posture comprehensively. It supports endpoint posture checks to ensure that devices meet security requirements such as updated antivirus signatures, recent operating system patches, and encryption status. If a device fails to meet these criteria, the cloud 100 can automatically adjust or block its network access. By integrating with third-party tools like endpoint detection and response, vulnerability scanners, and Security Information and Event Management (SIEM) systems, the cloud 100 enriches posture data and enforces zero trust principles.

Risk configurations and policy enforcement are handled centrally through admin portals, where administrators set granular rules based on user or group identity, device type, and application category. Various embodiments use a combination of threat intelligence, machine learning, and user and entity behavior analytics to assign risk scores to network activities, adjusting policies accordingly and potentially requiring additional verification for higher-risk actions. The platform performs real-time inspection of both plain-text and encrypted traffic, employing advanced threat intelligence and sandboxing to detect malicious content. Built-in Data Loss Prevention (DLP) features examine uploads and downloads for sensitive information such as Personally Identifiable Information (PII) or payment card data, helping organizations satisfy compliance requirements such as General Data Protection Regulation (GDPR), Health Insurance Portability and Accountability Act (HIPAA), and Payment Card Industry Data Security Standard (PCI-DSS).

Security controls within the cloud 100 are designed to enforce zero trust principles, ensuring that no user or device is implicitly trusted. Zscaler Private Access (ZPA), for instance, replaces traditional VPNs by brokering secure, application-level connections to internal resources. This approach restricts users to only the specific applications they need, eliminating broad network-level access. Zscaler's Cloud Access Security Broker (CASB) capabilities help tenants manage their sanctioned and unsanctioned SaaS applications, preventing unsafe cloud usage while offering granular controls over file uploads, downloads, and data sharing. Meanwhile, core web security and Uniform Resource Locator (URL) filtering protect against malicious websites, botnets, and phishing attacks, and suspicious files can be escalated to sandbox environments for deeper analysis.

The cloud's real-time dashboards give security teams immediate visibility into traffic patterns, policy enforcement events, and threat intelligence updates. The cloud 100 captures comprehensive transaction logs for each user session, which can be stored in SIEM platforms for further correlation and long-term archiving. Because the platform is entirely cloud-native, threat intelligence updates and new security features are automatically propagated throughout a global network, meaning all customers can benefit from newly detected attack signatures or policy improvements within seconds.

Overall, the cloud's architecture and feature set enable organizations to maintain a robust security posture without the complexity of managing on-premises hardware or backhauling traffic through centralized data centers. By combining global scalability, real-time inspection, and zero trust-based policy enforcement, the cloud 100 offers a streamlined way for tenants to oversee asset posture, configure risk profiles, and implement granular security controls that adapt to evolving threats. This end-to-end approach ensures that even as the business and threat landscapes change, organizations remain protected and maintain compliance with industry standards.

Tenants can configure their compliance controls in the cloud 100 by first defining and mapping their specific regulatory or corporate requirements (e.g., HIPAA, PCI-DSS, GDPR) to the available security and data protection features within the cloud admin portal. This involves creating policies in areas like DLP, access control, etc. based on the organization's risk tolerance and compliance mandates. Administrators can then customize these rules at a granular level, for instance, by specifying particular data patterns (e.g., credit card numbers or social security numbers) or user groups that require additional scrutiny. They may also integrate with other security tools to extend visibility and automate enforcement actions. Throughout this process, administrators can view real-time dashboards to monitor traffic, measure policy effectiveness, and generate compliance-centric reports. Regular reviews and audits of the policies, potentially guided by best practice frameworks like NIST, ISO 27001, or CIS Benchmarks, help ensure that controls remain up to date and aligned with evolving regulatory requirements.

### Compliance Control

Compliance controls for organizational networks consist of policies, procedures, and technical measures that ensure legal, regulatory, and industry requirements are met while protecting data and operations. These controls generally align with frameworks such as International Organization for Standardization (ISO) 27001, National Institute of Standards and Technology (NIST) Special Publication (SP) 800-53, PCI-DSS, HIPAA, and GDPR, among others. One core element is governance, which includes well-defined security policies, roles, responsibilities, and processes for continuous risk assessment. Organizations must ensure that vendors and third-party service providers also comply with security standards through contractual agreements and due diligence.

On the technical side, access control and identity management are critical to enforcing the principle of least privilege and preventing unauthorized access. Network segmentation helps contain breaches within isolated areas, reducing potential damage, while robust data encryption secures information both in transit and at rest. Equally vital are logging, monitoring, and intrusion detection, facilitated by tools like Security Information and Event Management (SIEM) platforms that analyze activities for threats. Vulnerability management programs and regular patching processes further fortify the network by identifying and mitigating weaknesses before they are exploited. Secure configuration and hardening measures, such as disabling unnecessary services and adhering to industry benchmarks, serve to reduce the overall attack surface.

On the operational front, incident response procedures guide teams through identifying, containing, and eradicating security incidents, followed by root-cause analysis to strengthen future defenses. Change management processes ensure that updates or new implementations in the network infrastructure are authorized and properly tested before going live. Backup and disaster recovery plans protect critical data against loss and provide guidelines for timely recovery following interruptions. Security awareness training programs help employees recognize threats like phishing and social engineering, fostering a security-conscious culture.

Auditing and continuous improvement efforts involve both internal and external audits to validate compliance and provide transparency to stakeholders. Regular monitoring, metrics, and reporting provide leadership with a clear overview of the organization's security posture. Management reviews and governance committees address any identified gaps, approve necessary investments, and align the security roadmap with overall business objectives. These layered strategies work together under a defense-in-depth approach that combines robust technical safeguards, policy enforcement, and an ongoing commitment to adaptability, ultimately ensuring that the organization remains resilient in an ever-evolving threat landscape.

Implementing compliance controls can be a complex undertaking for organizations because each industry and regulatory framework has its own unique requirements and interpretations. Organizations often face challenges in determining which controls are truly necessary for their specific operations, data types, and threat landscape. With an ever-changing regulatory environment, it can be difficult to stay current on newly introduced standards or revised guidelines, especially if the organization operates in multiple jurisdictions with varying compliance mandates. Additionally, identifying the right balance between security and practicality is often challenging; overly restrictive controls can hamper productivity or create operational bottlenecks, while insufficient controls leave the organization exposed to potential breaches and noncompliance penalties. Limited resources, both in terms of personnel expertise and budget, further complicate the selection and implementation of appropriate safeguards. Consequently, decision-makers must conduct thorough risk assessments, align controls with business objectives, and collaborate with various stakeholders to ensure that the chosen controls meet both compliance and operational needs without unduly constraining the organization's day-to-day activities.

### Automated Compliance Control Mapping

As described, traditional methods of compliance control mapping necessitate considerable manual labor and significant expertise in both security and compliance domains. Organizations often find themselves grappling with the complex task of aligning security findings with pertinent compliance controls across various frameworks. This process is frequently hindered by inconsistencies, errors, and inefficient implementation strategies. The existing solutions fall short as they lack the capability to automatically pinpoint relevant controls, verify their applicability, and offer practical guidance for implementation. The core challenge lies not only in identifying the correct controls but also in ensuring their proper validation and providing actionable steps for their implementation.

The present disclosure handles these challenges by leveraging an advanced Large Language Model (LLM) agent equipped with Retrieval-Augmented Generation (RAG) capabilities. This innovative approach employs specialized tools designed for control search and validation. By doing so, it ensures precise and practical compliance mapping across multiple frameworks, all the while maintaining consistency and furnishing detailed implementation guidance. This solution significantly enhances the efficiency and accuracy of compliance control mapping, ultimately streamlining the process for organizations and reducing the likelihood of errors and inconsistencies.

As described, the present systems and methods leverage an LLM Agent combined with RAG capabilities to automatically analyze security findings and deliver comprehensive compliance control recommendations. This sophisticated system employs a dual-tool architecture, featuring Control_Search and Validate_Control tools to ensure precise control retrieval.

The Control_Search tool takes advantage of RAG to identify relevant controls and understand their interrelationships, while the Validate_Control tool ensures the accuracy of these controls through a systematic validation process. An intelligent workflow is implemented by the system, which encompasses the analysis of security findings, the search for pertinent controls, the validation of selections, and the generation of comprehensive implementation guidance.

A key feature of this system is its continuous validation process, which incorporates a scoring mechanism. In certain embodiments, if a control scores below 80%, the system initiates refined searches to enhance accuracy. This ensures a high level of precision in the recommendations provided. The system adeptly maintains framework-specific context while applying a consistent methodology across various compliance frameworks, resulting in the generation of detailed implementation strategies and thorough risk analyses for each identified control.

Moreover, the system's ability to preserve framework-specific context while maintaining a consistent methodology significantly enhances the practicality and relevance of its recommendations. It generates time-based implementation strategies, identifies control relationships and dependencies, and provides comprehensive risk analyses, including assessments of residual risks and compensating controls. The continuous refinement process not only improves the accuracy of control mapping but also ensures that organizations receive practical, actionable guidance for implementing security controls.

The system's flexibility in adapting to various compliance needs, coupled with its automated efficiency, ensures that it maintains high accuracy and consistency in its recommendations. This makes the system an invaluable tool for organizations seeking to streamline their compliance processes and enhance their overall security posture. By delivering detailed, reliable, and actionable compliance control recommendations, the system supports organizations in effectively managing and mitigating security risks across diverse compliance frameworks.

The Control_Search tool is a sophisticated component designed to streamline the process of identifying relevant compliance controls within a comprehensive knowledge base. Its primary purpose is to efficiently search through this knowledge base to find controls that are pertinent to specific compliance requirements. This tool is equipped with several advanced capabilities to enhance its functionality and effectiveness.

Firstly, it performs framework-specific control searches, meaning it can tailor its search process to the particular compliance framework being utilized. This ensures that the controls it identifies are directly applicable to the specific regulatory or industry standards that an organization needs to adhere to.

Secondly, the Control_Search tool is capable of complete control information retrieval. It doesn't just identify the controls but also extracts all relevant information associated with them. This includes details about the control's purpose, scope, and any specific requirements or conditions that must be met.

Additionally, the tool identifies related controls that may be interconnected or that complement the primary controls identified. This holistic approach ensures that organizations are aware of all relevant controls and how they interrelate, which can be crucial for comprehensive compliance strategies.

Finally, the Control_Search tool provides implementation guidance extraction. Beyond just identifying controls, it extracts practical guidance on how these controls can be implemented effectively. This includes step-by-step instructions, best practices, and any other relevant information that can assist organizations in applying these controls in their operational environments.

The Validate_Control tool is another essential component designed to ensure the accuracy and relevance of compliance controls identified by the system. Its primary purpose is to validate and score the relevance of these controls, thereby providing a reliable foundation for implementing effective compliance strategies. This tool includes several critical capabilities that enhance its functionality and effectiveness.

First, the Validate_Control tool performs Control ID verification. This capability ensures that the control identifiers are accurate and correspond correctly to the controls in the compliance knowledge base. By verifying the Control ID, the tool eliminates any discrepancies that could arise from misidentified or misclassified controls, thereby ensuring the integrity of the compliance mapping process.

Next, the tool engages in content validation. It meticulously examines the content of each identified control to confirm its applicability and relevance to the specific security findings and compliance requirements. This thorough validation process ensures that the controls are not only correctly identified but also contextually appropriate for the organization's specific compliance needs.

The tool also features a relevance scoring capability. Each control is assigned a score based on its relevance and applicability to the compliance requirements at hand. This scoring mechanism provides a quantifiable measure of how well a control meets the necessary criteria, helping organizations prioritize and implement the most pertinent controls. In some embodiments, controls that score below a certain threshold, such as 80%, may trigger refined searches to identify more suitable alternatives, further enhancing the accuracy of the recommendations.

Additionally, the Validate_Control tool conducts gap analysis. This involves identifying any gaps between the current compliance posture and the desired state of compliance. By highlighting areas where controls are insufficient or missing, the tool enables organizations to address these deficiencies proactively. This comprehensive analysis ensures that all aspects of compliance are covered, and no critical areas are overlooked.

Again, the system's integration of RAG technology significantly enhances its capability to provide precise and comprehensive compliance solutions. This integration is achieved through several advanced mechanisms, each contributing to the system's overall effectiveness in compliance control mapping. The system utilizes a comprehensive knowledge base of compliance controls. This extensive repository includes a wide array of controls from various compliance frameworks and standards. By having access to such a thorough and detailed knowledge base, the system can draw from a vast pool of information to identify the most relevant and accurate controls for any given compliance requirement.

The system further incorporates context-aware search mechanisms. These advanced search methods take into account the specific context of the compliance requirements and security findings. By understanding the context in which the controls are needed, the system ensures that the search results are highly relevant and tailored to the specific needs of the organization. This context-aware approach greatly enhances the precision of the control identification process.

Additionally, the system validates the identified controls against official documentation. This step is crucial in ensuring that the controls not only exist within the knowledge base but also align with the latest standards and guidelines issued by official regulatory bodies. By cross-referencing with authoritative sources, the system guarantees that the recommended controls are up-to-date, compliant, and reliable.

Furthermore, the system performs relationship mapping between controls. This involves identifying and mapping the interrelationships between various controls to provide a comprehensive view of how they interact and support each other. Understanding these relationships is essential for implementing a cohesive and effective compliance strategy, as it highlights dependencies and complementary controls that work together to achieve compliance objectives.

In summary, the integration of RAG technology in the system enhances its ability to deliver precise and comprehensive compliance control recommendations. By leveraging a comprehensive knowledge base, employing context-aware search mechanisms, validating against official documentation, and mapping relationships between controls, the system ensures that organizations receive accurate, relevant, and actionable compliance guidance. This advanced integration significantly improves the efficiency and effectiveness of compliance processes, helping organizations maintain robust compliance postures.

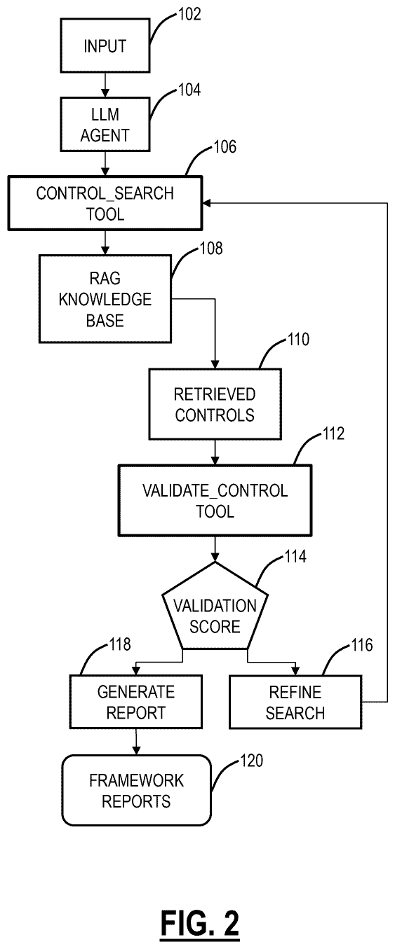

FIG. 2 is a flow diagram of an automated compliance control mapping workflow. In various embodiments, the system operates through a meticulously structured workflow, designed to ensure thorough and accurate compliance control mapping. This structured thought process includes a plurality of critical stages, each contributing to the overall precision and effectiveness of the system's recommendations.

In order to utilize the present system, an input 102 can be provided to the LLM agent 104. This input 102 can be automatically generated by scanning an organizations environment/network to discover findings. This automated discovery can be performed by the components of the cloud-based system, i.e., the cloud 100, for its various tenants. Additionally, administrators can provide inputs based on known vulnerabilities. An example input 102 can include the following:

Name: Outdated SSL/TLS Version.

Description: The server uses an old TLS version making it easier for attackers to intercept, decrypt, or manipulate sensitive data.

Based thereon, the first stage includes an initial control search. During this stage, the system leverages its advanced Control_Search tool 106 to scan the comprehensive knowledge base 108 for relevant compliance controls. The search is tailored to the specific compliance framework and contextual requirements, ensuring that the identified controls are pertinent to the organization's unique compliance needs. Based thereon, the system retrieves one or more controls 110.

Following the initial search, the system proceeds to a control validation stage. Here, the Validate_Control tool 112 comes into play, meticulously examining the identified controls to verify their accuracy and relevance. This involves cross-referencing the controls with official documentation and evaluating their applicability to the specific security findings. The validation process ensures that only the most appropriate and effective controls are considered for implementation.

Based on this validation process, a validation score 114 is computed by the Validate_Control tool 112. This validation score 114 can be a score between 0-100, a larger score meaning a more appropriate and effective control. Each of the one or more retrieved controls 110 can be assigned a score. If any controls are found lacking during the validation stage, the system enters a refinement stage 116. In this stage, controls that score below a certain threshold, such as 80% or any other preconfigured threshold, trigger a refined search process. This iterative approach allows the system to enhance the accuracy and relevance of the controls by identifying better-suited alternatives. The refinement stage is crucial for maintaining high standards of precision in the system's recommendations.

Once the controls have been refined and verified, the system moves to a final validation stage. This stage involves a thorough re-evaluation of the refined controls to ensure they meet all necessary criteria and are ready for implementation. The final validation acts as a quality control measure, confirming that the recommended controls are both accurate and effective.

The last stage in the workflow is comprehensive report generation 118. After the controls have been validated and finalized, the system compiles all the findings into a detailed report 120. This report includes a summary of the identified controls, their validation status, implementation guidance, and any relevant risk analyses. The comprehensive report provides organizations with clear, actionable insights to guide their compliance efforts.

In conclusion, the system's agent workflow follows a structured and rigorous thought process, encompassing initial control search, control validation, refinement (if needed), final validation, and comprehensive report generation. Each stage is designed to ensure the identification, validation, and implementation of accurate and relevant compliance controls, ultimately supporting organizations in maintaining robust and effective compliance postures.

It will be appreciated that the described components such as the Control_Search tool, Validate_Control tool, administrative portals, and the LLM agent can be executed in the cloud 100. That is, the automated compliance control described herein can be provided by the cloud 100 for its various tenants based on their specific compliance requirements.

The present systems and methods revolutionize the intricate task of compliance control mapping by transforming it into an automated, intelligent process. Leveraging LLM agent technology with RAG capabilities, the system drastically reduces the time and expertise traditionally required for compliance mapping while ensuring high levels of accuracy and consistency. The sophisticated dual-tool architecture, comprising Control_Search and Validate_Control tools, facilitates thorough validation of control selections. Simultaneously, the framework-specific approach guarantees that the implementation guidance provided is both relevant and practical.

Organizations benefit immensely from this innovation, experiencing significantly faster compliance mapping processes with reduced manual effort. The system ensures consistent results and offers practical implementation strategies that are both timely and actionable. Additionally, it provides comprehensive risk analysis and monitoring requirements, thereby ensuring effective compliance management. The flexibility to adapt to various compliance frameworks, coupled with its automated efficiency, makes this system a valuable asset for organizations dealing with complex compliance requirements across multiple frameworks. This leads to an overall improvement in compliance posture and risk management.

This invention offers several key advantages over traditional compliance mapping methods. Enhanced accuracy is achieved through systematic validation processes, and the system's comprehensive analysis includes detailed control relationships and thorough implementation strategies. Framework flexibility supports multiple compliance frameworks, ensuring that the system can be universally applied across different regulatory landscapes. Practical implementation guidance is provided with clear timelines and success criteria, making it easier for organizations to follow and implement. Furthermore, risk-aware recommendations encompass compensating controls and monitoring requirements, providing a holistic approach to compliance management.

By automating the compliance mapping process while maintaining high accuracy and offering practical guidance, the system significantly enhances organizations' ability to implement and sustain effective compliance programs across multiple frameworks. This innovative approach not only streamlines the compliance process but also ensures that organizations are well-equipped to manage and mitigate risks efficiently.

### Process for Automated Compliance Control

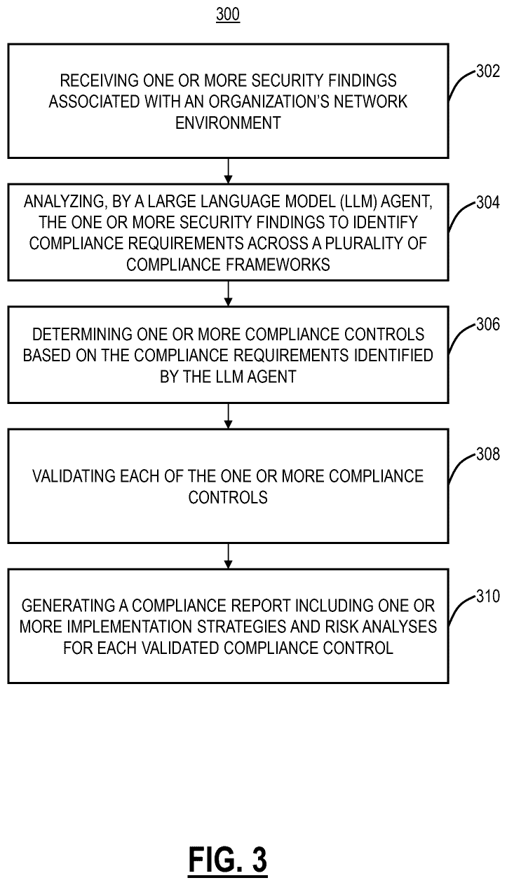

FIG. 3 is a flowchart of a process 300 for automated compliance control. In various embodiments, the process 300 can be contemplated as a method having steps, processing devices configured to implement the steps, a cloud-based system configured to implement the steps, and as a non-transitory computer-readable medium storing instructions for programming one or more processors to execute the steps. The process 300 includes receiving one or more security findings associated with an organization's network environment (step 302); analyzing, by a Large Language Model (LLM) agent, the one or more security findings to identify compliance requirements across a plurality of compliance frameworks (step 304); determining one or more compliance controls based on the compliance requirements identified by the LLM agent (step 306); validating each of the one or more compliance controls (step 308); and generating a compliance report including one or more implementation strategies and risk analyses for each validated compliance control (step 310).

The process 300 further includes performing a context-aware search of a knowledge base storing compliance controls to retrieve a set of potentially relevant compliance controls. The validating can include (i) verifying control identifiers against a knowledge base, (ii) performing content validation to confirm applicability of the one or more compliance controls to the security findings, and (iii) computing a relevance score for each validated compliance control. The steps can include refining at least one of the one or more compliance controls in response to a relevance score falling below a predetermined threshold. The compliance report can include the validated compliance controls, assigned relevance scores, and implementation guidance for each of the validated compliance controls. The determining one or more compliance controls can include performing framework-specific control searches that tailor retrieval based on an identified regulatory or industry standard. The determining one or more compliance controls can include identifying related controls that supplement or complement primary controls to provide a holistic compliance strategy. The validating can include cross-referencing identified compliance controls with official regulatory documentation to confirm alignment with latest compliance standards; and performing a gap analysis to highlight compliance deficiencies, thereby enabling proactive remediation strategies. Generating the compliance report can include (i) identifying control dependencies and relationships among validated compliance controls, (ii) documenting compensating controls for areas where primary controls alone are insufficient, and (iii) providing continuous monitoring requirements for ongoing compliance assurance. The steps can include identifying the one or more security findings via an automated cloud-based system, or receiving the one or more security findings from an administrator of the organization.

### Processing Circuitry and Non-transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method comprising steps of:
receiving one or more security findings associated with an organization's network environment;
analyzing, by a Large Language Model (LLM) agent, the one or more security findings to identify compliance requirements across a plurality of compliance frameworks;
determining one or more compliance controls based on the compliance requirements identified by the LLM agent;
validating each of the one or more compliance controls; and
generating a compliance report including one or more implementation strategies and risk analyses for each validated compliance control.

2. The method of claim 1, wherein the determining one or more compliance controls includes performing a context-aware search of a knowledge base storing compliance controls to retrieve a set of potentially relevant compliance controls.

3. The method of claim 1, wherein the validating includes (i) verifying control identifiers against a knowledge base, (ii) performing content validation to confirm applicability of the one or more compliance controls to the security findings, and (iii) computing a relevance score for each validated compliance control.

4. The method of claim 3, wherein the steps comprise refining at least one of the one or more compliance controls in response to a relevance score falling below a predetermined threshold.

5. The method of claim 3, wherein the compliance report includes the validated compliance controls, assigned relevance scores, and implementation guidance for each of the validated compliance controls.

6. The method of claim 1, wherein the determining one or more compliance controls includes performing framework-specific control searches that tailor retrieval based on an identified regulatory or industry standard.

7. The method of claim 1, wherein the determining one or more compliance controls includes identifying related controls that supplement or complement primary controls to provide a holistic compliance strategy.

8. The method of claim 1, wherein the validating comprises:
cross-referencing identified compliance controls with official regulatory documentation to confirm alignment with latest compliance standards; and
performing a gap analysis to highlight compliance deficiencies, thereby enabling proactive remediation strategies.

9. The method of claim 1, wherein generating the compliance report includes (i) identifying control dependencies and relationships among validated compliance controls, (ii) documenting compensating controls for areas where primary controls alone are insufficient, and (iii) providing continuous monitoring requirements for ongoing compliance assurance.

10. The method of claim 1, wherein the steps include identifying the one or more security findings via an automated cloud-based system, or receiving the one or more security findings from an administrator of the organization.

11. A non-transitory computer-readable storage medium having computer-readable code stored thereon for programming one or more processors to perform steps of:
receiving one or more security findings associated with an organization's network environment;
analyzing, by a Large Language Model (LLM) agent, the one or more security findings to identify compliance requirements across a plurality of compliance frameworks;
determining one or more compliance controls based on the compliance requirements identified by the LLM agent;
validating each of the one or more compliance controls; and
generating a compliance report including one or more implementation strategies and risk analyses for each validated compliance control.

12. The non-transitory computer-readable storage medium of claim 11, wherein the determining one or more compliance controls includes performing a context-aware search of a knowledge base storing compliance controls to retrieve a set of potentially relevant compliance controls.

13. The non-transitory computer-readable storage medium of claim 11, wherein the validating includes (i) verifying control identifiers against a knowledge base, (ii) performing content validation to confirm applicability of the one or more compliance controls to the security findings, and (iii) computing a relevance score for each validated compliance control.

14. The non-transitory computer-readable storage medium of claim 13, wherein the steps comprise refining at least one of the one or more compliance controls in response to a relevance score falling below a predetermined threshold.

15. The non-transitory computer-readable storage medium of claim 13, wherein the compliance report includes the validated compliance controls, assigned relevance scores, and implementation guidance for each of the validated compliance controls.

16. The non-transitory computer-readable storage medium of claim 11, wherein the determining one or more compliance controls includes performing framework-specific control searches that tailor retrieval based on an identified regulatory or industry standard.

17. The non-transitory computer-readable storage medium of claim 11, wherein the determining one or more compliance controls includes identifying related controls that supplement or complement primary controls to provide a holistic compliance strategy.

18. The non-transitory computer-readable storage medium of claim 11, wherein the validating comprises:
cross-referencing identified compliance controls with official regulatory documentation to confirm alignment with latest compliance standards; and
performing a gap analysis to highlight compliance deficiencies, thereby enabling proactive remediation strategies.

19. The non-transitory computer-readable storage medium of claim 11, wherein generating the compliance report includes (i) identifying control dependencies and relationships among validated compliance controls, (ii) documenting compensating controls for areas where primary controls alone are insufficient, and (iii) providing continuous monitoring requirements for ongoing compliance assurance.

20. The non-transitory computer-readable storage medium of claim 11, wherein the steps include identifying the one or more security findings via an automated cloud-based system, or receiving the one or more security findings from an administrator of the organization.
